(19) United States
(12) Patent Application Publication
(10) Pub. No.: US 2015/0176900 A1
(43) Pub. Date: Jun. 25, 2015

(54) HYBRID OXY-COAL BURNER FOR EAF STEELMAKING

(71) Applicants: American Air Liquide, Inc., Fremont, CA (US); L'Air Liquide, Societe Anonyme pour l'Etude et Exploitation des Procedes Georges Claude, Paris (FR)

(72) Inventors: Kenneth KA, Bear, DE (US); Yuan XUE, Wilmington, DE (US); Michael G.K. GRANT, Versailles (FR)

(73) Assignees: American Air Liquide, Inc., Fremont, CA (US); L'Air Liquide, Societe Anonyme pour l'Etude et Exploitation des Procedes Georges Claude, Paris (FR)

(21) Appl. No.: 14/136,211

(22) Filed: Dec. 20, 2013

(51) Int. Cl. F27B 3/20; F27D 11/08; F27B 3/08; C21C 7/00

(52) U.S. Cl. CPC F27B 3/205; C21C 7/0025; C21C 7/0087; F27D 11/08; F27B 3/085; C21C 2300/02

(57) ABSTRACT

Methods and apparatus for processing a metal using a hybrid burner are described herein. The costs of melting and refining metal, such as iron, using standard burners is subject to fluctuation. The hybrid burners described herein are capable of burning both standard fuels as well as solid carbon-containing fuels, like coal. Through the use of a hybrid burner in either standard or modified electric arc furnaces, the costs for melting and refining an iron source can be reduced both through the costs of fluid hydrocarbon fuel sources and through the reduced or eliminated need for external carbon sources during refining.

### BACKGROUND OF THE INVENTION

1. Field of the Invention

Embodiments described herein generally relate to metal processing. Specifically, embodiments described herein relate to a hybrid burner for heating a source material.

2. Description of the Related Art

Electric arc furnaces (EAFs) are widely used in steelmaking and in smelting of nonferrous metals. EAF steelmaking accounts for roughly a third of overall steelmaking production worldwide and greater than 50% of production in the U.S. alone. Melting in an EAF is accomplished by supplying energy to the furnace interior. This energy can be electrical or chemical. Electrical energy is supplied via the electrodes and is usually the largest contributor (over 50%) in melting operations. Typical EAFs operate at power levels from 10 MW to 100 MW.

By the nature of the design of the electric arc furnace, hot spots are created in the furnace in areas adjacent to the electrodes. The energy from the electrodes, however, creates hotspots in the scrap. These hotspots create harsh conditions for the water cooled furnace walls and the refractory lining located adjacent to the hotspots. Further, the electrical energy, when considering the 38-40% efficiency of electricity arriving at the steel plant and the 50% efficiency in conversion to heat in the EAF, is relatively inefficient. To overcome these problems, most modern operations supplement the electrical energy with chemical energy, such as that delivered by oxy-fuel burners. Chemical energy may be supplied via several sources including oxy-fuel burners and oxygen lances. Oxy-fuel burners generally burn natural gas using oxygen or a blend of oxygen and air. Heat is transferred to the scrap by flame radiation and convection by the hot products of combustion. Heat is transferred within the scrap by conduction. The oxygen reacts with the hot scrap and burns iron to produce intense heat for “cutting” the scrap. Once a molten pool of steel is generated in the furnace, oxygen can be injected directly into the bath. This oxygen will react with several components in the bath including, aluminum, silicon, manganese, phosphorus, carbon and iron. All of these reactions are exothermic and supply additional energy to aid in the melting of the scrap. The metallic oxides that are formed will combine with the charged lime to make a liquid slag.

The economics of electric arc furnace technology are strongly dependent on the efficiency with which electrical energy is introduced into the metal bath. For many years, the use of a practice to create foaming of the liquid slag has been well-established for low-alloy steel production. Foamy slag improves the thermal efficiency of melting, lowers refractory and electrode consumption, and provides stable arcing at a reduced noise level. Foamy slag can be obtained by injecting carbon and oxygen into the slag which floats on the liquid steel. Slag foaming increases the electric power efficiency by at least 20% in spite of a higher arc voltage. The net energy savings, from foaming the slag, are estimated at 5-7 kWh/ton steel.

The oxy-fuel burners and chemical energy from oxygen lancing are relatively efficient, delivering up to 50% of the available energy to the melting process in the EAF. Further, these burners help equalize heat delivered to the scrap by heating the “cold spots” in the furnace. However, the price fluctuation for fuels such as natural gas can create an unforeseeable cost burden to the steel producer. In a typical EAF, using typical oxy-fuel burners, approximately 1 million tons per year of steel are produced. Approximately 5 Nm³ of natural gas per ton of steel tapped are consumed by the burners. Over a period of a year, this equals to 5 million Nm³ which equals approximately 1 million dollars per year in natural gas costs. With dramatic seasonal price fluctuations of natural gas, this cost can increase significantly.

Therefore, there is a continuing need in the art for increased cost savings and greater stability in overhead costs related to the melting process.

### SUMMARY OF THE INVENTION

The invention described herein generally relates to a hybrid burner for heating a source material and provide reagent in the refining process. In one embodiment, a hybrid burner can include a burner body connected with a combustion chamber. The burner body can include a hybrid fuel source channel having a proximal fuel opening for receiving a solid or fluid fuel and a distal fuel opening for transmitting the solid or fluid fuel, an oxidizing gas channel having a proximal gas opening and a distal gas opening and a supersonic gas channel. The combustion chamber can include one or more combustion chamber walls and a first outlet nozzle in connection with the supersonic gas channel, a second outlet nozzle in connection with the distal fuel opening of the hybrid fuel source channel, a third outlet nozzle in connection with the distal gas opening of the oxidizing gas channel and a flame discharge opening formed distal to the third outlet nozzle.

In another embodiment, a method for processing metals can include receiving a metal in a furnace, the furnace comprising one or more electrodes and one or more hybrid burners; delivering electrical energy using the one or more electrodes to heat the metal, creating one or more hot spots and one or more cold spots; delivering a fluid fuel, a solid carbon-containing fuel or combinations thereof through the one or more hybrid burners, the hybrid burners comprising a combustion chamber, a fluid fuel channel, a solid carbon-containing fuel channel and an oxidizing gas channel; delivering an oxidizing gas through the hybrid burner to combine with the fluid fuel, the solid carbon-containing fuel or combinations thereof in the combustion chamber; combusting either the fluid fuel or the solid carbon-containing fuel or both in the presence of the oxidizing gas; and delivering a carbon source to the metal during melting and/or refining of the metal.

In another embodiment, a method of refining a metal can include positioning an iron source in an electric arc furnace, the electric arc furnace comprising at least one hybrid burner; flowing a fluid fuel and an oxidizing gas through the hybrid burner into the electric arc furnace; combusting the fluid fuel in the presence of the oxidizing gas inside the electric arc furnace to heat the iron source to a first temperature; delivering a solid carbon-containing fuel and the oxidizing gas through the hybrid burner after the iron source has locally reached the first temperature; and combusting the solid carbon-containing fuel in the presence of the oxidizing gas to heat the iron source to a second temperature.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a schematic view of an EAF furnace with a hybrid burner according to one embodiment;

FIGS. 2A-2C are schematic drawings of iron processing using a hybrid burner according to one embodiment;

FIGS. 3A-3C illustrate a hybrid burner and a combustion chamber incorporating separate fuel channels according to one embodiment

FIGS. 4A and 4B illustrate a hybrid burner with a decentralized carbon injection channel according to one embodiment;

FIGS. 5A and 5B illustrate a hybrid burner with a combined fuel channel according to one embodiment; and

FIG. 6 is a flow diagram of a method for refining a metal, according to one embodiment.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Natural gas is currently the main fossil fuel used in the EAF heating process, excluding fossil fuels used in the production of electricity. However, the standard price of natural gas, the seasonal fluctuations in price and local availability, among other factors, contribute to the need for more cost-effective burners for use in EAF steelmaking. Coal has been historically a relatively cheap fuel compared to natural gas, both as measured by standard costs, number of cost fluctuations and amount of cost fluctuation per occurrence. Further, coal is widely available in the U.S., China and India, all of which are large steel producing regions. As such, coal is a considerable alternative for production of chemical energy for the EAF steelmaking process.

Embodiments described herein generally relate to methods and apparatus for steelmaking using coal as a fuel source. Specifically, embodiments described herein generally relate to a hybrid fuel burner and methods and systems for steel refining using one or more hybrid fuel burners. To use coal or other solid carbon sources as the only fuel source for burners in an EAF would create technological challenges due to the nature of EAF batch processing. Specifically, coal has a relatively high ignition temperature in comparison to natural gas, propane or other available fluid fuel sources. As such, when the furnace temperature is very low, initiating and maintaining the coal flame after charging the raw materials would be very challenging. However, a hybrid fuel burner, which could start using a fluid hydrocarbon fuel (e.g. natural gas, propane, etc) and then introduce a solid carbonaceous fuel as either a supplement or a substitute to the fluid hydrocarbon fuel, could fit straight forward into the process route of typical EAF operations. From time to time it may be attractive to use during a batch the hybrid fuel burner using only the fluid fuel source without changing to the solid carbonaceous fuel. Choice of this operating mode would depend on, for example, economics of the operation.

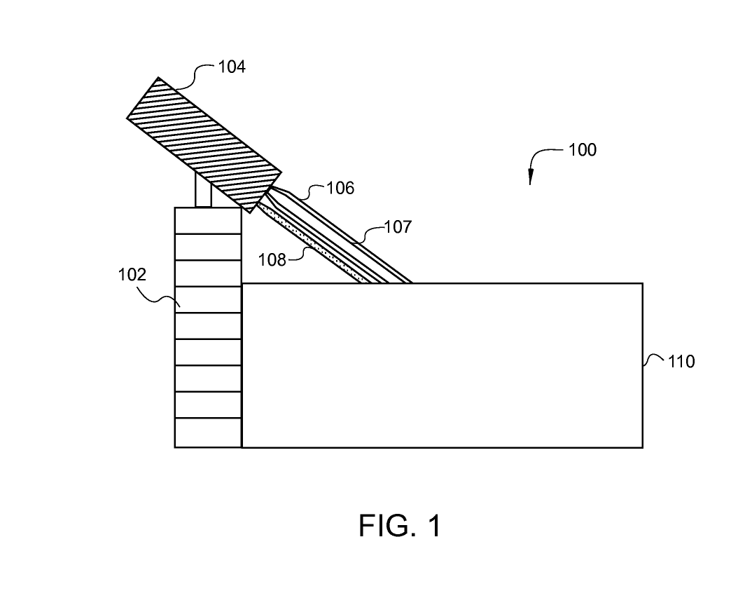

FIG. 1 is a schematic view of an EAF 100 with a hybrid burner 104 according to one embodiment. Embodiments described herein relate to relevant portions of a typical EAF 100 useable with one or more embodiments of the invention. There can be other components that are not explicitly named which may be included or excluded based on the choice of design and other parameters. The components described herein may differ in shape, size or positioning from those used in practice. Further, the embodiments described herein are for exemplary purposes and should not be read as limiting of the scope of the invention, unless explicitly limited herein.

The EAF 100 can include a hybrid burner 104 positioned in connection with a wall 102. The hybrid burner 104 is positioned in the EAF 100 so as to supplement the heating delivered from the electrodes (not shown) of the EAF 100. In normal operation, EAF 100 can be loaded (charged) with a source material 110, such as scrap metal. The source material 110 can also include a flux, such as lime, for separating impurities into the slag. The hybrid burner 104 can deliver a controllable flow of fluid hydrocarbon fuel in the presence of an oxidizing gas. The fluid hydrocarbon fuel can include known fuels used in the production of steel, such as natural gas or propane. The oxidizing gas is normally a gas with a composition of between 20.9% oxygen and 100% oxygen, for example standard air or pure oxygen. The combination of the fluid hydrocarbon fuel and the oxidizing gas are combusted to produce an oxygen-fuel combustion gas 106. The oxygen-fuel combustion gas 106 is directed toward the source material 110 for heating and melting. As the source material 110 reaches an appropriate temperature, such as above at least 1400 degrees Celsius, the flow of fuel is reduced and the flow of oxidizing gas is increased to create a highly oxidizing flame. The heat released by exothermic oxidation can melt an additional portion of the source material 110 located near the oxygen-fuel combustion gases 106. The hybrid burner 104 can deliver a supersonic oxidizing gas 107 to further assist the melting. The supersonic oxidizing gas 107 is delivered at an increased velocity which can allow for an additional portion of the preheated scrap located further from the flame to be cut, burned and melted.

Heating and melting the source material 110 located near the burner creates both high temperatures and an opening in the source material 110. Once the temperatures are appropriately high, such as above 1000 degrees Celsius, the hybrid burner can switch from using the fluid hydrocarbon fuel to the solid carbonaceous fuel for production of the oxygen-fuel combustion 107. Solid carbonaceous fuels can include coal, high carbon scrap, biowaste, plastics or other high carbon sources with combined carbon and hydrogen content of greater than 50%. In one embodiment, the solid carbonaceous fuel is bituminous coal. When using coal as the solid carbonaceous fuel source, the coal particle size can be less than or equal to 3 mm in diameter.

The use of gas burners for melting scrap during the early part of the melt down cycle can establish an empty space (cavity) and a hot environment prior to converting the hybrid burner 104 to a solid fuel. First, the combustion of coal or other solid carbonaceous fuels requires significant heat and space for combustion. Attempting to switch to solid carbonaceous fuels too early (when cavity size is too small and temperature of the scrap are too low) can lead to subsequent improper ignition and therefore, heating.

High velocity oxygen, preferably supersonic oxygen, is used in the refining process to remove impurities from the liquid charge. However, a byproduct of the refining process is the formation of iron-oxygen compounds, such as Iron (II) oxide (FeO), which mix into the slag. If these compounds are left unrecovered, the iron volume produced in the cycle will be diminished. Foaming the slag helps increase thermal efficiency during the refining period. By adding carbon to the slag, the FeO is reduced in the following reaction producing bubbles of CO gas that are entrained in the slag to create a foam:

C+FeO→CO+Fe

In the embodiments described above, slag foaming does not require external sources of carbon beyond the carbon used for the hybrid combustion process to form carbon monoxide and carbon dioxide. As the solid carbonaceous fuel source is combusted, carbon is released both as an oxide (gas) in the internal atmosphere and as combusted particulate (ash and residual carbon). Thus, carbon is injected into the charge material as it is being refined from the burned solid carbonaceous fuel. The solid carbonaceous fuel can be delivered by a gas propulsion. The gas propulsion can include various combustible or inert gases, such as natural gas, nitrogen, hydrogen, argon, or helium.

The carbon sources act as an additional nucleation site for the formation of carbon monoxide from the FeO and non-combusted oxygen present in the melted material 110. Optionally, additional carbon may be injected into the melted metal material 110 as shown at carbon source 108. The carbon source 108 can be any high carbon source, such as particulate anthracite coal, coke, etc. Therefore, the hybrid burner 104 both reduces costs associated with standard fuels in EAF steelmaking and provides a carbon source for foamy slag formation.

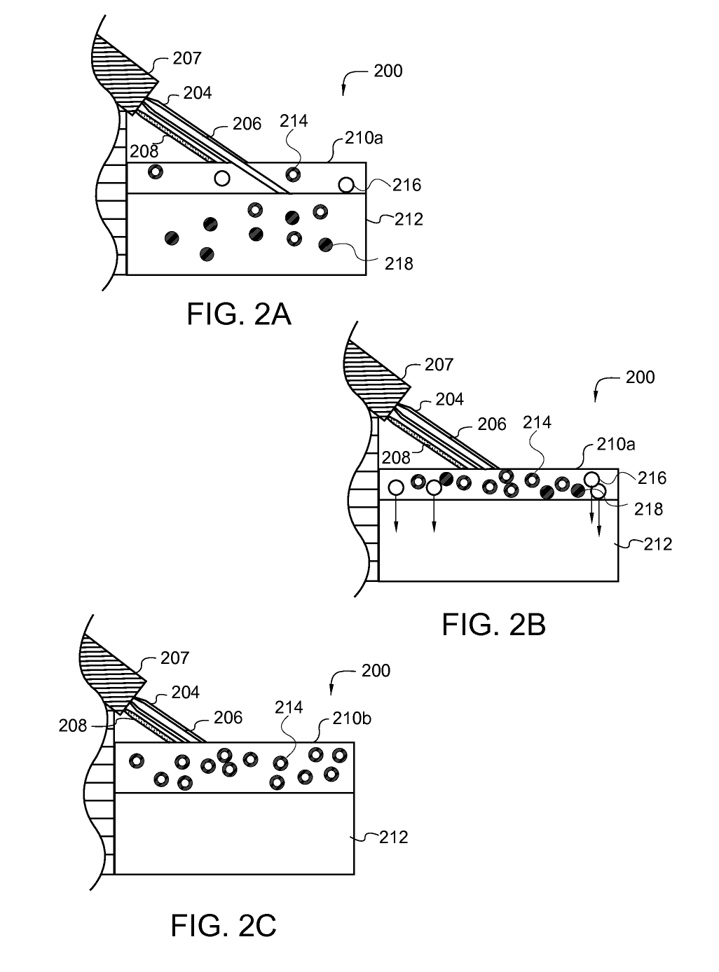

FIGS. 2A-2C are a schematic drawing of the steel processing system using a hybrid burner according to one embodiment. FIG. 2A depicts a first portion of the steel processing system in an EAF 200 with a hybrid burner 207. As described above, the hybrid burner 207 can produce an oxygen-fuel combustion 204 as well as a supersonic oxidizing gas 206 which can be used sequentially and in conjunction with the electrodes of the EAF 200 to melt the source material. Melting the source material, along with carbon added during the hybrid combustion process, creates the melted metal 212 and flat slag 210a. In one or more embodiments, the melted metal 212 is primarily iron based such as steel.

The flow of the injected oxidizing gas may be directed through a dedicated nozzle for oxidizing gas injection, through a nozzle of another gas that has previously fired toward the same predetermined furnace area, and/or through the nozzle of an oxidizing gas lance device external to the nozzles which is also directed toward the predetermined furnace area. In the flat slag 210a is carbon-oxygen compounds 214, such as carbon monoxide and carbon dioxide, and iron oxides 216, such as FeO. In solution in the melted metal 212 is carbon 218. The carbon 218 here can be derived from a number of sources, such as from the solid carbonaceous fuel combustion or, to a greater extent, from the source material. It is anticipated that the combustion of the solid carbonaceous fuel by the hybrid burner 204 can be a primary source of carbon 218 in the melted metal 212 and flat slag 210a. Supersonic oxygen 206 is then injected into the flat slag 210a and the melted metal 212 to oxidize the carbon 218 to carbon-oxygen compounds 214. Injected oxidizing gas both reduces carbon in the molten source and produces gaseous carbon-oxygen compounds 214 for foamy slag formation.

FIG. 2B depicts a second portion of the steel processing system. The heat delivered in the melting process creates a flat slag 210a and a melted metal 212, which forms a bath underlying the flat slag 210a. The carbon-oxygen compounds 214 are entrained in the flat slag 210a and newly formed iron oxygen compounds 216 are dissolved readily in the flat slag 210a. At this point, carbon 218 from further oxygen fuel combustion 204 is injected into the flat slag 210a. The carbon 218 reacts with the iron-oxygen compounds to reduce the iron and form further carbon-oxygen compounds 214.

The reduced iron is no longer soluble in the flat slag 210a and returns to the melted metal 212. The carbon-oxygen compounds 214 escape by bubbling through the flat slag 210, which is composed primarily of silicon and calcium oxides, along with other compounds which are formed in the oxidation process. Optionally, the carbon 218 can be supplemented by a carbon source 208. The carbon source 208 may be the same as the carbon source 108 described with reference to FIG. 1. In one embodiment, the carbon source 208 is particulate coal, such as particulate anthracite coal.

FIG. 2C depicts a third portion of the steel processing system. Carbon 218, as shown in FIG. 2A, either derived from the combustion of the solid carbonaceous fuel or from carbon source 208, oxidizes to form carbon-oxygen compounds 214. The carbon-oxygen compounds 214 are generally gaseous compounds and thus rise into and out of the flat slag 210a.

Optionally, carbon can be added to the flat slag 210b and the melted metal 212 to create the foamy slag 210b. The carbon delivered to the melted metal is generally in the form of coal. Within the same time frame, the supersonic oxygen 206 can be delivered toward a predetermined area of the furnace. The supersonic oxygen 206 may be delivered at a high velocity (not necessarily supersonic velocity) and with oxygen content in excess of about 50 volume % oxygen, preferably with an oxygen content exceeding 90 volume %. The supersonic oxygen 206 is directed within proximity of the same predetermined area as the hybrid burner 207 and the optional carbon source 208 to assist in the formation of CO, which foams the slag formed or being formed in the predetermined area. As not shown, a part of the supersonic oxygen 206 will penetrate through the foamy slag 210b and react with the melted metal 212 for refining purposes.

The foamy slag 210b is used to increase the thermal efficiency of the furnace during the refining period, when the side walls are fully exposed to the arc radiation. A foaming slag will rise and cover the electric arcs, thus permitting the use of a high tap (high voltage) setting without increasing the thermal load on the furnace walls. In addition, an electrical arc covered by a foaming slag will have a higher efficiency in transferring the energy into the melted metal phase.

In the system described above, the solid carbonaceous fuel combusted in the hybrid burner 207 provides a dual benefit. First, the hybrid burner allows for higher efficiency in the heating/melting process. The hybrid burner 207 combusts a first fuel which is a conventional fuel to both increase temperature and to create an opening in the source material. Once the opening is formed, the hybrid burner 207 switches to the solid carbonaceous fuel, which can be combusted alone or in conjunction with a standard fuel source, thus providing a cost savings. Second, the hybrid burner 207 either supplements or supplants the standard carbon source 208. During the combustion process, the coal produces carbon byproducts which will enter through the hybrid burner 207 into the slag 210 and the melted metal 212. Thus, the energy costs described here are further reduced both by the combustion of the solid carbonaceous fuel and by the resulting combusted carbon from the hybrid burner 207, as described above. From time to time it may be attractive to use during a batch the hybrid fuel burner using only the fluid fuel source without changing to the solid carbonaceous fuel. Choice of this operating mode would depend on, for example, economics of the operation.

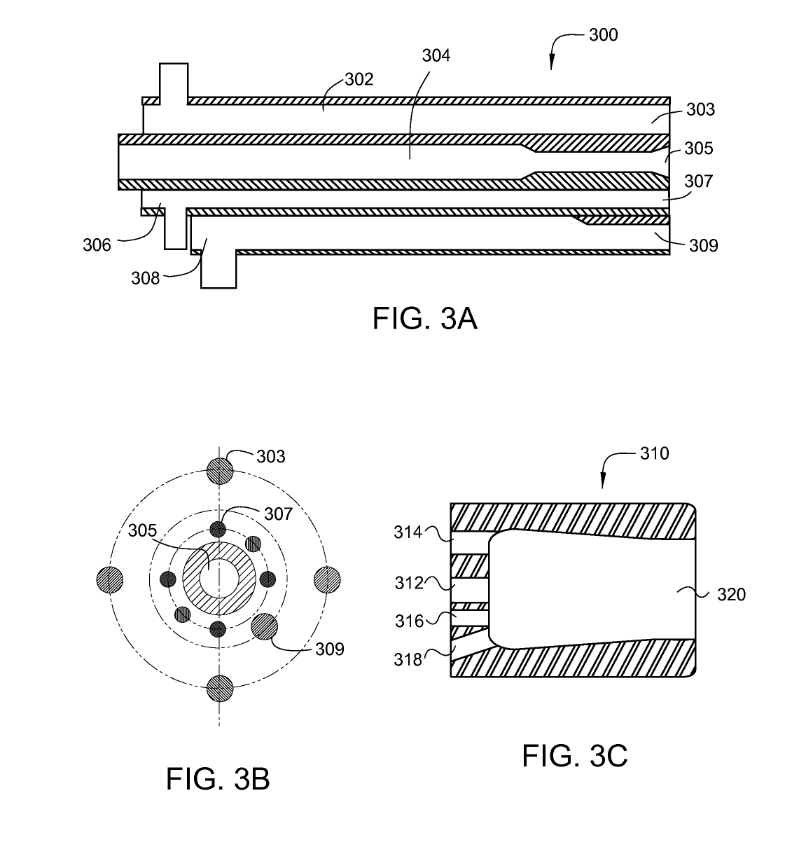

FIGS. 3A-3C illustrate a hybrid burner 300 and a combustion chamber 310 incorporating separate fuel channels according to one embodiment. FIG. 3A depicts a cut away side view of the hybrid burner according to one embodiment. The hybrid burner 300 can include one or more combustion solid channels 302 each with a combustion solid port 303, one or more supersonic oxygen channels 304 each with a supersonic oxygen port 305, one or more fluid hydrocarbon channels 306 with a fluid hydrocarbon port 307 and one or more oxidizing gas channels 308 each with an oxidizing gas port 309. FIG. 3B depicts a frontal view of the hybrid burner 300 according to the embodiment of FIG. 3A. In this embodiment, the hybrid burner 300 is depicted with four combustion solid ports 303, the supersonic oxygen port 305, six fluid hydrocarbon ports 307, and the oxidizing gas port 309. Though hybrid burner 300 here is depicted here as having a specific number of ports, the hybrid burner 300 as practiced may have more or less ports and more or less connected channels than shown in the embodiment described here. The ports can be connected with respective channels and ports formed in the combustion chamber 310. In the embodiment of FIGS. 3A and 3B, the hybrid burner 300 has separate fuel channels for the solid carbonaceous fuel and the fluid hydrocarbon fuel, thus allowing independent fuel delivery during the refining process.

The hybrid burner 300 can comprise two separate types of fuel channels, such as the combustion solid channels 302 and the fluid hydrocarbon channels 306. In the initial portion of operation, the hybrid burner 300 can deliver a standard hydrocarbon fuel through the fluid hydrocarbon channels 306. Standard hydrocarbon fuels can include natural gas, liquid propane, coke oven gas, blast furnace gas, reformed natural gas, gas from gasification of coal, biowaste products, municipal gas, carbon monoxide or other gaseous and liquid hydrocarbons. Though the above examples use hydrocarbon gases as the fuel, other gases combustible in the presence of an oxidizing gas may be used, such as hydrogen. The standard hydrocarbon fuel exits the fluid hydrocarbon channels 306 through the respective fluid hydrocarbon port 307 and into the combustion chamber 310 (not shown).

In a separate portion of the hybrid burner 300, an oxidizing gas is flowed through the oxidizing gas channels 308 to the respective oxidizing gas port 309. The oxidizing gas can include various oxidizing gases, such as an oxygen containing gas. In one embodiment, the oxygen containing gas can contain between 20.9 volume % and 100 volume % oxygen. The oxidizing gas can then be delivered through the oxidizing gas port 309 to the combustion chamber 310.

In the combustion chamber 310, the standard hydrocarbon fuel is mixed with the oxidizing gas in an appropriate combustion mixture. The combustion mixture is determined by the overall concentration of the hydrocarbon gas as compared to the oxidizing gas based on the flow rates and velocities from the oxidizing gas channels 308 and the fluid hydrocarbon channels 306. Once properly mixed, the gases are combusted and delivered to the source material as described above.

Once the appropriate temperatures are reached, the hybrid burner 300 can produce heat using the solid fuel source. In this embodiment, the solid fuel source is delivered through the combustion solid channels 302 to the respective combustion solid port 303. The solid fuel source can be a wide variety of solid carbonaceous fuel sources including coal, biowaste, or any other carbon-containing matter with a high carbon content (such as a carbon content of at least 50 atomic %). The solid fuel source should be of a particulate size that can be completely combusted so as to prevent undesired particulate matter from directly entering the melted source material. In one or more embodiments, the solid fuel source is composed or comprises particles no larger than about 3 mm in diameter.

In one or more embodiments, the solid fuel source is propelled through the combustion solid channel 302 using a combustible or inert fluid. Without intending to be bound by theory, it is believed that due to the temperature and the friction in the combustion solid channel 302, that particulate matter will not be capable of consistent flow through the channel without some propulsion. By co-flowing either an inert gas or another fuel gas with the solid fuel source, the flow of the solid fuel source in the combustion solid channel 302 can be maintained constant and the solid fuel can be delivered to the combustion chamber 310 in appropriate ratios and at an appropriate rate.

The solid fuel source can then be propelled through the combustion solid port 303 and into the combustion chamber. The combustion solid channels 302 are depicted here as a cylinder, however the channels described here may be of any shape and size based on the needs or desires of the user. Channel shapes useable with embodiments described herein include cubic/rectangular shapes, conic shapes, or other varieties or combinations of shapes such that there is an opening and a port formed for exiting material.

The supersonic oxygen channels 304 can be formed centrally in the hybrid burner 300. The supersonic oxygen channel 304 can further be formed annularly with an entrance for the oxygen formed at the proximal end and the supersonic oxygen port 305 formed at the distal end. The hybrid burner 300 can include a convergent-divergent nozzle, such as a Laval nozzle, located in connection with the supersonic oxygen port 305. To those skilled in the art, supersonic speeds can be achieved by blowing oxygen through a convergent-divergent nozzle. The convergent-divergent nozzle is characterized by a flow passage whose cross sectional area decreases in the direction of flow and attains a minimum cross section area and then increases further in the direction of flow.

FIG. 3C depicts the combustion chamber 310 according to one or more embodiments. The combustion chamber 310 described herein is an exemplary embodiment. As such, sizes and positioning of the components of the combustion chamber 310 described herein are for description purposes only. The combustion chamber 310 as practiced by those skilled in the art may differ in one or more respects form the combustion chamber 310 as disclosed herein. Further, only components necessary for the description of combustion chamber 310 are disclosed herein. Thus, other components including more or fewer of the described components, which are not specifically described herein, may be included without diverging from the scope of the invention.

The hybrid burner 300 can be connected with a combustion chamber 310. The combustion chamber 310 can include a first outlet nozzle 312, a second outlet nozzle 314, a third outlet nozzle 316, a fourth outlet nozzle 318 and a flame discharge opening 320. The first outlet nozzle 312 can connect with the supersonic oxygen port 305 for delivery of high velocity oxygen. The second outlet nozzle 314 can connect with the combustion solid port 303. The third outlet nozzle 316 can connect with the fluid hydrocarbon port 307. The fourth outlet nozzle 318 can connect with the oxidizing gas port 309.

The second outlet nozzle 314, third outlet nozzle 316 and fourth outlet nozzle 318 receive fuel and oxidizing gas from the respective channels, described with reference to FIGS. 3A and 3B. Once received in the combustion chamber 310, the fuel can be combusted with the oxidizing gas to produce a flame for melting the metal charged in the furnace. The flame produced is delivered to the metal though the flame discharge opening 320.

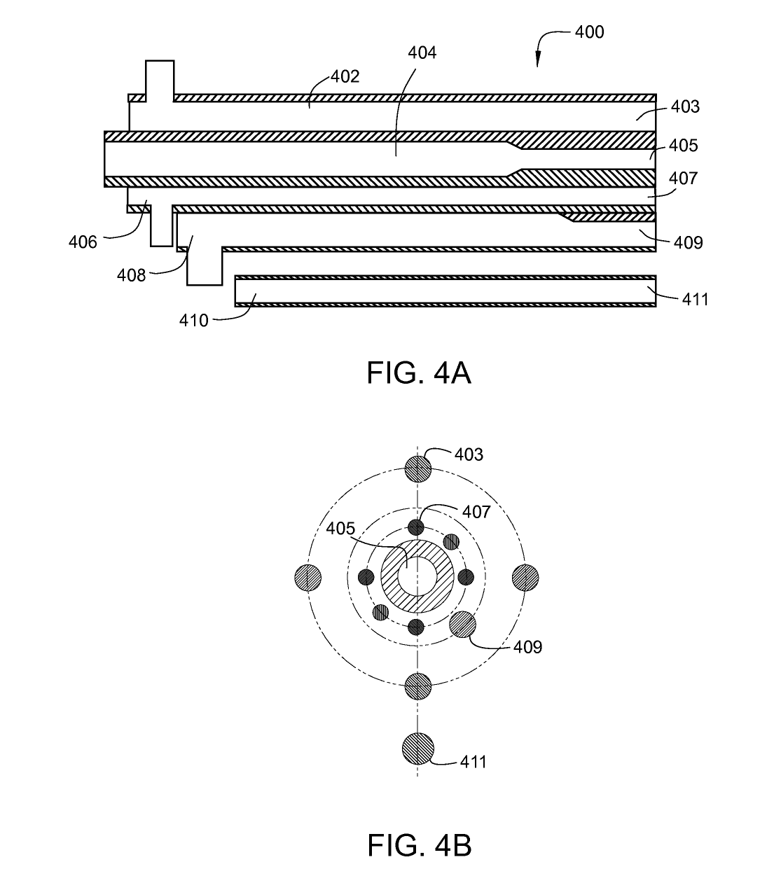

FIGS. 4A and 4B illustrate a hybrid burner with a decentralized carbon injection channel according to one embodiment. FIG. 4A depicts a cut away side view of the hybrid burner according to one embodiment. The hybrid burner 400 can include one or more combustion solid channels 402 each with a combustion solid port 403, one or more supersonic oxygen channels 404 each with a supersonic oxygen port 405, one or more fluid hydrocarbon channels 406 with a fluid hydrocarbon port 407, one or more oxidizing gas channels 408 each with an oxidizing gas port 409 and one or more external carbon channels 410 each with a carbon port 411. FIG. 4B depicts a frontal view of the hybrid burner 400 according to the embodiment of FIG. 4A. In this embodiment, the hybrid burner 400 is depicted with four combustion solid ports 403, the supersonic oxygen port 405, six fluid hydrocarbon ports 407, the oxidizing gas port 409 and the carbon port 411. As described with reference to FIG. 3B, the hybrid burner 400 as practiced may have more or less ports and more or less connected channels than shown in the embodiment described here. The ports can be connected with respective channels and ports formed in the combustion chamber. In the embodiment of FIGS. 4A and 4B, the hybrid burner 400 has separate fuel channels for the solid carbonaceous fuel and the fluid hydrocarbon fuel alongside an external carbon source, thus allowing independent fuel delivery as well as separately controlled carbon delivery during the refining process.

The hybrid burner 400 can comprise the combustion solid channels 402 and the fluid hydrocarbon channels 406. In the initial portion of operation, the hybrid burner 400 can deliver a standard hydrocarbon fuel through the fluid hydrocarbon channels 406. The standard hydrocarbon fuel exits the fluid hydrocarbon channels 406 through the respective fluid hydrocarbon port 407 and into the combustion chamber (not shown). In a separate portion of the hybrid burner 400, an oxidizing gas is flowed through the oxidizing gas channels 408 to the respective oxidizing gas port 409. The oxidizing gas can include oxygen containing gases. The oxidizing gas can then be delivered through the oxidizing gas port 409 to the combustion chamber. In the combustion chamber, the standard hydrocarbon fuel is mixed with the oxidizing gas for combustion. Once properly mixed, the gases are combusted and delivered to the source material as described above.

Once the appropriate temperatures are reached, the hybrid burner 400 can produce heat using the solid fuel source. In this embodiment, the solid fuel source is delivered through the combustion solid channels 402 to the respective combustion solid port 403. The solid fuel source can be the same composition and have the same size parameters as one or more of the solid fuel sources described with reference to FIGS. 3A and 3B. In one or more embodiments, the solid fuel source is propelled through the combustion solid channel 402 using a combustible or inert fluid, such as a combustible or inert gas. In one embodiment, the solid fuel source is propelled with nitrogen gas. The solid fuel source can then be propelled through the combustion solid port 403 and into the combustion chamber. The combustion solid channels 402 are depicted here as a cylinder, however the channels described here may be of any shape and size based on the needs or desires of the user. Channel shapes useable with embodiments described herein include cubic/rectangular shapes, conic shapes, or other varieties or combinations of shapes such that there is an opening and a port formed for exiting material.

The supersonic oxygen channels 404 can be formed centrally in the hybrid burner 400. The supersonic oxygen channel 404 can further be formed annularly with an entrance for the oxygen formed at the proximal end and the supersonic oxygen port 405 formed at the distal end. The hybrid burner 400 can further include a convergent-divergent nozzle for increasing oxygen velocity.

The hybrid burner 400 can further comprise the external carbon channels 410. The external carbon channels 410, one of which is shown here, can flow a carbon source through the carbon port 411 and into the melted metal and slag. The carbon source can thus assist CO formation for foaming the slag and reduction of oxide species in the melted metal and the slag. In one or more embodiments, the hybrid burner 400 may be designed to provide only heat to melt the source material without delivering the carbon byproduct of burning the solid carbonaceous fuel. The carbon byproduct can be redirected away from the source material or the melted metal/slag using an evacuation system, such as a baghouse evacuation system. Once the carbon source from the hybrid burner is largely evacuated from the chamber, the carbon port 411 can supplement carbon into the melted metal and the slag, such as by flowing small particulate carbon source. The carbon source can have a high percent fixed carbon and a low sulfur content, e.g. anthracite buckwheat #5.

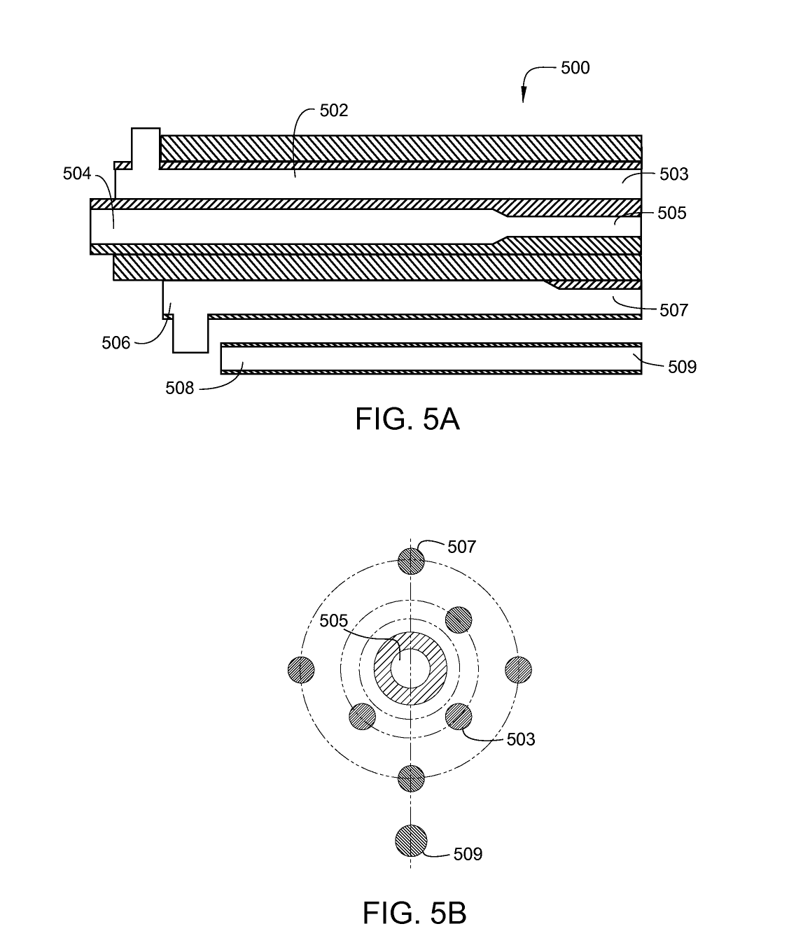

FIGS. 5A and 5B illustrate a hybrid burner with a combined fuel channel according to one embodiment. FIG. 5A depicts a cut away side view of the hybrid burner according to one embodiment. The hybrid burner 500 can include one or more hybrid combustion channels 502 each with a hybrid combustion port 503, one or more supersonic oxygen channels 504 each with a supersonic oxygen port 505, one or more oxidizing gas channels 506 each with an oxidizing gas port 507 and optionally one or more external carbon channels 508 each with a carbon port 509. FIG. 5B depicts a frontal view of the hybrid burner 500 according to the embodiment of FIG. 5A. In this embodiment, the hybrid burner 500 is depicted with three hybrid combustion ports 503, the supersonic oxygen port 505, the four oxidizing gas ports 507 and the carbon port 509. As described with reference to FIG. 3B, the hybrid burner 500 as practiced by those skilled in the art may have more or less ports and more or less connected channels than shown in the embodiment described here. The ports can be connected with respective channels and ports formed in the combustion chamber. In the embodiment of FIGS. 5A and 5B, the hybrid burner 500 has combination fuel channel for the solid carbonaceous fuel and the fluid hydrocarbon fuel alongside an optional external fuel source. The quantity, rate and flow of each fuel can be adjusted independently to allow for desired concentrations of the fluid hydrocarbon fuel and the solid carbonaceous fuel as appropriate for combustion and providing carbon to the melted metal/slag.

The hybrid burner 500 can comprise hybrid combustion port 503. In the initial portion of operation, the hybrid burner 500 can deliver a standard hydrocarbon fuel through the hybrid combustion channels 502. The standard hydrocarbon fuel exits the hybrid combustion channels 502 through the respective hybrid combustion port 503 and into the combustion chamber (not shown). In a separate portion of the hybrid burner 500, an oxidizing gas is flowed through the oxidizing gas channels 506 to the respective oxidizing gas port 507. The oxidizing gas can include various oxidizing gases as described above. The oxidizing gas can then be delivered through the oxidizing gas port 507 to the combustion chamber. In the combustion chamber, the standard hydrocarbon fuel is mixed with the oxidizing gas for combustion. Once properly mixed, the gases are combusted and the energy delivered to the source material as described above.

Once the appropriate temperatures are reached, the solid fuel source can be flowed into the hybrid combustion channel 502. In this embodiment, hydrocarbon gas may be maintained at any concentration or shut off as the solid fuel source is delivered into the hybrid combustion channel. The solid fuel source can be delivered into the hybrid combustion channels 502 at either the final concentration of solid fuel or with a gradual temporal increase from the starting concentration to the final concentration. The solid fuel source can be the same composition and have the same size parameters as one or more of the solid fuel sources described with reference to FIGS. 3A and 3B. In one or more embodiments, the solid fuel source is propelled through the hybrid combustion channels 502 using a combustible or inert fluid. The solid fuel source can then be propelled through the hybrid combustion port 503 and into the combustion chamber. The hybrid combustion channels 502 are depicted here as a cylinder, however the channels described here may be of any shape and size based on the needs or desires of the user.

The supersonic oxygen channels 504 can be formed centrally in the hybrid burner 500. The supersonic oxygen channel 504 can further be formed annularly with an entrance for the oxygen formed at the proximal end and the supersonic oxygen port 505 formed at the distal end. The hybrid burner 500 can further include a convergent-divergent nozzle for increasing oxygen velocity.

The hybrid burner 500 can further comprise the optional external carbon channels 508. The external carbon channels 508, one of which is shown here, can flow a carbon source through the carbon port 509 and into the melted metal and slag, as described with reference to FIGS. 4A and 4B. The carbon source here may be either a supplement to the carbon source derived from the combustion of the solid fuel source or it may be used in lieu of the carbon source form the combustion process, as described with reference to FIGS. 4A and 4B.

In one or more of the embodiments above, the carbon delivered during combustion of the solid fuel source may be supplemented by increasing the solid fuel delivered to the combustion chamber outside of the stoichiometric balance between the fuel source and the oxidizing gas, thus creating an excess of non-combusted carbon delivered to the source material or melted metal. Stated another way, in one embodiment, the solid fuel may be delivered such that a portion of the solid fuel is not combusted prior to delivery to the furnace chamber. One skilled in the art will understand that there are various permutations of the embodiments described herein. These permutations are within the scope of the invention as described.

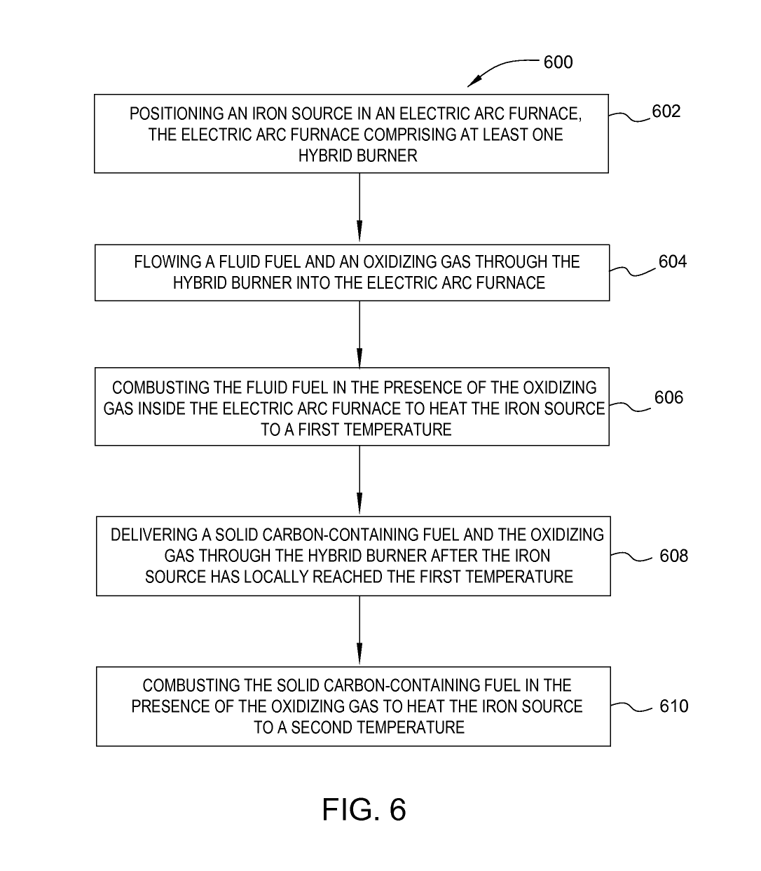

FIG. 6 is a flow diagram of a method 600 for refining a metal according to one embodiment. The method 600 begins at step 602 by positioning an iron source in an EAF, the EAF comprising at least one hybrid burner. In this embodiment, the EAF receives the iron source up to an appropriate fill level for an operation in a process known in the field as charging the furnace. The scrap is generally charged until the scrap reaches the roof of the EAF. The roof of the EAF is closed and electrical power can then be fed through the electrodes. The hybrid burners are positioned on the side of the EAF. The hybrid burners can be positioned so that cold spots in the furnace receive heat from at least one hybrid burner. Further, the EAF may have a combination of hybrid burners and standard burners, so long as at least one burner is a hybrid burner.

At step 604, a fluid fuel and an oxidizing gas are flowed through the hybrid burner and into the EAF. The fluid fuel can be any fluid fuel known in the art. The fuel may be a gaseous fuel or a liquid fuel. The fluid fuel may be a hydrocarbon fuel, such as natural gas, propane, methane, coke oven gas, blast furnace gas, gasified coal, gaseous products of biowaste, gaseous biowaste, carbon monoxide, hydrogen or combinations thereof. The oxidizing gas may be an oxygen-containing gas, such as standard air or a combination of oxygen with a second gas prepared from pure source gases.

At step 606, the fluid fuel can be combusted in the presence of the oxidizing gas inside the electric arc furnace, to heat the iron source to a first temperature. Because the scrap is generally against the face of the burner, there is often not enough space for the solid fuel to ignite. Further, the starting temperature of a furnace is not hospitable to combustion of a standard solid carbonaceous source, such as coal. In this case, the fluid fuel, such as a fluid hydrocarbon fuel, can be used initially to heat and melt the iron source because fluid fuels are generally easy to ignite and maintain. Heat from the fluid fuel will melt the scrap directly in front of the hybrid burner creating a hole in the scrap and increasing the local temperature.

At step 608, a solid carbon-containing fuel and the oxidizing gas can be delivered through the hybrid burner after the iron source has locally reached the first temperature. Once the hole is formed and the temperature is increased, the solid carbon-containing fuel will have the space and the temperature to be able to ignite. The solid carbon-containing fuel can then be delivered to the combustion chamber. The solid carbon-containing fuel should not be larger than 3 mm in diameter when complete combustion is desired, as this may create inadequate combustion. As described above, though the solid carbon-containing source is generally described as being delivered separately and sequentially after the fluid fuel source, in one or more embodiments the fuels may be delivered simultaneously or increasing in quantity as the temperature rises or as the capacity for combustion increases. From time to time it may be attractive during a batch to stop at step 606 using only the fluid fuel source without changing to the solid carbonaceous fuel. Choice of this operating mode would depend on, for example, economics of the operation.

At step 610, the solid carbon-containing fuel can be combusted in the presence of the oxidizing gas to heat the iron source to a second temperature. In this embodiment, the oxidizing gas may be continually delivered when changing between the fluid fuel and the solid carbon-containing fuel. In one or more embodiments, the fluid fuel and the solid carbon-containing fuel are delivered through the same channel of the hybrid burner. Once the oxidizing gas and the solid carbon-containing fuel are present in the combustion chamber, the mixture can be combusted to increase the temperature from the first temperature to the second temperature. The first temperature is generally defined as the temperature required for the solid carbon-containing fuel to combust, but can be a temperature above or below that temperature. The second temperature is generally defined as the temperature required for the refining process, such as the local temperature required to melt an area of the iron source. The local temperature to the burner may be higher than the melting temperature of the iron source, as melting the iron source is a function of both time and energy input. Further, the first temperature and the second temperature are not mutually exclusive of one another. Thus, the first temperature and the second temperature may be approximately equal.

### CONCLUSION

Embodiments described herein relate to a hybrid burner for heating a source material, the hybrid burner being capable of using a fluid fuel, a solid fuel or combinations thereof. Though liquid fuels are capable of supplementing an EAF with regards to melting and refining a metal, increasing costs of certain fuels and inefficiencies create a need for better burners. Disclosed herein is a hybrid burner capable of both using a solid fuel and incorporating the byproducts of that fuel beneficially into the melting process.

While the foregoing is directed to embodiments of the present invention, other and further embodiments of the invention may be devised without departing from the basic scope thereof, and the scope thereof is determined by the claims that follow.

What is claimed is:

1. A hybrid burner, comprising:
a burner body connected with a combustion chamber, the burner body comprising:
a hybrid fuel source channel having a proximal fuel opening for receiving a solid or fluid fuel and a distal fuel opening for transmitting the solid or fluid fuel;
an oxidizing gas channel having a proximal gas opening and a distal gas opening; and
a supersonic gas channel; and
the combustion chamber comprising:
one or more combustion chamber walls;
a first outlet nozzle in connection with the supersonic gas channel;
a second outlet nozzle in connection with the distal fuel opening of the hybrid fuel source channel;
a third outlet nozzle in connection with the distal gas opening of the oxidizing gas channel; and
a flame discharge opening formed distal to the third outlet nozzle.

2. The hybrid burner of claim 1, wherein the hybrid fuel source channel is capable of receiving both a solid fuel and a fluid fuel.

3. The hybrid burner of claim 1, further comprising an external carbon channel.

4. The hybrid burner of claim 1, wherein the supersonic gas channel and the first outlet nozzle are centrally located, as referenced from a bifurcation line.

5. The hybrid burner of claim 1, wherein the burner body further comprises a solid fuel source channel having a proximal fuel opening and a distal fuel opening.

6. The hybrid burner of claim 5, wherein the combustion chamber further comprises a second outlet nozzle in connection with the distal fuel opening of the solid fuel source channel.

7. The hybrid burner of claim 6, wherein the solid fuel source channel is in fluid connection with a fluid fuel source or an inert gas source.

8. The hybrid burner of claim 7, wherein the inert gas source is a nitrogen gas source or an argon gas source.

9. The hybrid burner of claim 1, further comprising a converging-diverging port in fluid connection between the supersonic gas channel and the first outlet nozzle.

10. A method comprising:
receiving a metal in a furnace, the furnace comprising one or more electrodes and one or more hybrid burners; and
melting the metal using the one or more hybrid burners, comprising:
delivering a fluid fuel through the one or more hybrid burners, the hybrid burners comprising a combustion chamber, a fluid fuel channel, a carbon-containing fuel channel and an oxidizing gas channel;
delivering an oxidizing gas through the hybrid burner to combine with the fluid fuel in the combustion chamber;
combusting the fluid fuel in the presence of the oxidizing gas to achieve a first temperature;
once the first temperature is achieved, delivering a solid carbon containing fuel through the one or more hybrid burners;
delivering an oxidizing gas through the hybrid burner to combine with the solid carbon containing fuel in the combustion chamber; and
combusting the solid carbon-containing fuel in the presence of the oxidizing gas to achieve a second temperature, wherein the solid carbon-containing fuel delivers a carbon source to the metal during combustion.

11. The method of claim 10, wherein the carbon source delivered to the metal during combustion comprises or is derived from the solid carbon-containing fuel.

12. The method of claim 10, wherein the solid carbon-containing fuel contains greater than 50 atomic % combination of carbon and hydrogen.

13. The method of claim 10, wherein the fluid fuel is selected from the group consisting of natural gas, propane, methane, coke oven gas, blast furnace gas, gasified coal, gaseous products of biowaste, gaseous biowaste, carbon monoxide, hydrogen or combinations thereof.

14. The method of claim 10, wherein the oxidizing gas comprises oxygen, air or combinations thereof.

15. The method of claim 14, wherein the oxidizing gas comprises between 20.9 volume % and 100.0 volume % oxygen.

16. The method of claim 10, wherein the fluid fuel and the solid carbon-containing fuel are combusted simultaneously.

17. The method of claim 10, further comprising delivering the solid carbon-containing fuel to the combustion chamber using a conveying gas.

18. The method of claim 17, wherein the conveying gas comprises air, natural gas, propane, hydrogen, inert gas or combinations thereof.

19. The hybrid burner of claim 18, wherein the inert gas is selected from a group consisting of nitrogen or argon.

20. A method comprising:
positioning an iron source in an electric arc furnace, the electric arc furnace comprising at least one hybrid burner;
combusting a fluid fuel in the presence of an oxidizing gas inside the electric arc furnace to heat the iron source to a first temperature;
delivering a solid carbon-containing fuel and the oxidizing gas through the hybrid burner after the iron source has locally reached the first temperature;
combusting the solid carbon-containing fuel in the presence of the oxidizing gas to heat the iron source to a second temperature and create a melted iron source and a flat slag; and
refining the melted iron source, the refining comprising:
delivering a high velocity oxidizing gas to the melted iron source and the flat slag; and
delivering a carbon source to the melted iron source and the flat slag, wherein the flat slag is converted to a foamy slag.

21. The method of claim 20, wherein the second temperature is higher than the first temperature.

22. The method of claim 20, wherein the solid carbon-containing fuel contains greater than 50 atomic % combination of carbon and hydrogen.

23. The method of claim 20, wherein the solid carbon-containing fuel is solid coal.

24. The method of claim 23, wherein the solid coal has a particle size of no greater than 3 mm.

25. The method of claim 23, wherein the solid coal is bituminous coal.

26. The method of claim 20, wherein the fluid fuel is selected from the group consisting of natural gas, propane, methane, other hydrocarbons, coke oven gas, blast furnace gas, gasified coal, gaseous products of biowaste, gaseous biowaste, carbon monoxide, hydrogen or combinations thereof.

27. The method of claim 20, wherein the first temperature is above 1000 degrees Kelvin.

28. The method of claim 20, wherein the high velocity oxidizing gas is a supersonic oxidizing gas.

29. The method of claim 20, wherein the carbon-containing fuel provides a heating value of at least 50 BTU/scf.
